(19) United States
(12) Patent Application Publication
(10) Pub. No.: US 2005/0026132 A1
(43) Pub. Date: Feb. 3, 2005

(54) Warm intermittent perfusion

(75) Inventors: Gregory M. Fahy, Corona, CA (US); TingChung Wang, Rochester, NY (US)

Correspondence Address: FOLEY & LARDNER, P.O. BOX 80278, SAN DIEGO, CA, 92138-0278, US

(73) Assignee: University of Rochester

(21) Appl. No.: 10/871,504

(22) Filed: Jun. 17, 2004

Related U.S. Application Data
(63) Continuation-in-part of application No. 10/011,959, filed on Nov. 5, 2001, now abandoned.
(60) Provisional application No. 60/245,959, filed on Nov. 3, 2000.

(51) Int. Cl. A01N 1/00; A01N 1/02

(52) U.S. Cl. 435/1.1

(57) ABSTRACT

The present invention provides an intermittent perfusion method and system which is capable of extending the viable life of an explanted mammalian heart for up to at least approximately 49 hours by utilizing a new and unique intermittent perfusion method or procedure. The system that implements the method includes a perfusion chest of approximately the same size as the standard ice chests that are currently being used to store and transport human organs. The perfusion chest of the present invention, however, contains all of the mechanical and electrical components needed to automatically perfuse the heart in accordance with the perfusion procedure.

This application is a continuation-in-part of U.S. application Ser. No. 10/011,959, filed Nov. 5, 2001, which claims priority to U.S. provisional application Ser. No. 60/245,959, filed Nov. 3, 2000, each of which are hereby incorporated by reference in its entirety, including all tables, figures, and claims.

### FIELD OF THE INVENTION

The present invention relates to the perfusion of mammalian organs, and particularly to the warm intermittent perfusion of human organs being stored below about 10° C. for subsequent use in organ transplantation or biomedical research.

### DESCRIPTION OF THE RELATED ART

Over the past three decades, immense resources have been devoted to extending the successful period of preservation of organs in general and hearts in particular, but simple static storage at the melting point of ice for no more than about 4 to 6 hours remains virtually the only method that is used for clinical cardiac preservation today. Essentially, when an organ is transported from one site to another for the purpose of transplantation, the organ is generally placed in an ice chest for transport, and this method is very limited in its ability to maintain the organ in transplantable condition.

The need for longer organ preservation times is clear, especially in the case of hearts. Limited donor organ availability severely restricts the number of cardiac transplants that can be performed. In the face of this shortage, there is a tendency to use hearts immediately upon procurement, thus sometimes creating the impression that extended preservation times are unnecessary. But the mere fact that a surgeon transplants a heart does not mean the surgeon has provided the best service he can to patients. Operating under an “immediate transplant” policy almost always dooms heart recipients to receiving organs that have poor histocompatibility with the recipient. It is not impossible to perform local HLA testing within the typical approximately 6-hour storage limit, but it is virtually impossible to obtain good matches for most patients by drawing on a small local donor pool, and this matters. As pointed out by Smith et al. in a 1995 paper in the Lancet (volume 346, pp. 1318-1322, 1995), the cardiac transplant survival rates in relation to the number of DR locus mismatches are as follows:

| | Heart Transplant | | |
|---|---|---|---|
| Number of | Survival Rates after | | |
| Mismatches | 1 year | 5 years | 10 years |
| None | 92% | 83% | 76%, |
| One | 81% | 73% | 59% |
| Two | 78% | 70% | 52% |

Thus, after 10 years, 100%×(1−76/52)=46% more patients will be alive if they receive well-matched as opposed to imperfectly matched (only two mismatches) hearts, and numerous other studies have now confirmed the same basic conclusion for hearts and other organs as well. Matching matters, and transcontinental matching is not practical without extended cardiac preservation. In the case of kidneys, which are preserved for about 24-36 hours, perfect matching is accomplished in about 5% of the transplants that are done. In the case of hearts, the perfect matching rate is much smaller than this, but could substantially exceed the renal matching rate if preservation times could be extended to 48 hours. Furthermore, extending the safe preservation time for kidneys to 48 hours or beyond would further improve the long-term success rate for kidney transplantation, for the same reason.

Beyond the issue of rejection, performing transplants on an emergency basis is expensive, and it cannot be argued that performing surgery in the middle of the night or right after the patient has consumed a heavy meal is ideal for the patient or for the surgeon. It cannot be argued that an organ that is better preserved is not preferable to an organ that is poorly preserved, or that a known and large safety margin is not preferable to a small and uncertain safety margin. Prior to the advent of UW solution, about half of renal donors were not liver or heart donors, and it was argued that this was due to the poor quality of the uncollected livers and hearts. Nevertheless, when UW solution successfully extended the acceptable preservation time for the liver, the present inventors observed a sudden 50% increase in the fraction of renal donors that were also liver donors. Heart preservation times were not improved by UW solution, however, and no improvement in cardiac procurement rates took place. It is therefore to be anticipated that, as in the case with livers, extended cardiac preservation will result in the collection and transplantation of more human hearts.

There are hints in the literature that intermittent perfusion of an organ during simple cold storage might allow somewhat better preservation of the organ for transplant. Intermittent perfusion traditionally refers to the periodic interruption of static cold storage with bouts of perfusion at defined times, each bout of perfusion being maintained for a defined time at a defined perfusion pressure and at a defined temperature.

The primary alternative approaches to cardiac preservation include simple cold storage (no perfusion), continuous perfusion, and “microperfusion” (continuous perfusion at very low flow rates to avoid-the problems of continuous perfusion). However, these alternatives fall short. Simple cold storage cannot maintain metabolic activity, and therefore the “housekeeping” needed for life must continuously decline over time. On the other hand, continuous perfusion, which can continuously support cellular maintenance systems, can induce endothelial damage. Also, while continuous perfusion supplies O₂ and nutrients and eliminates toxic metabolic end-products, perfusion with crystalloids induces myocardial edema due to enhanced microvascular fluid filtration in the face of a cessation of lymphatic flow. Enhanced cell swelling due to the increased availability of water for cellular uptake reduces myocardial compliance (makes the heart “stiff’), decreases left ventricular volume and impairs function. The edema problem is observed with continuous perfusion even with very low perfusion rates coupled with oncotic support from 6% hydroxyethyl starch, whereas this problem does not occur with intermittent perfusion. Finally, microperfusion suffers from an inability to overcome the critical closing pressure of myocardial capillaries, and therefore to attain uniform distribution of perfusate throughout the heart. These alternative methods, therefore, all appear to be intrinsically less feasible for long-term use than intermittent perfusion.

Hypothermic multidose cardioplegia has long been used routinely during open heart surgery. There are also studies of prolonged functional preservation of rat hearts using multidose cardioplegia or intermittent perfusion. Agrawall et al (Brit. J. Surg. 63: 508-11, 1976) found that intermittent perfusion for 2 minutes every 6 hours preserved the viability of the isolated rat heart during 24-hour storage, as determined by the ability of the heart to beat for 10 minutes or more under non-working conditions after heterotopic transplantation. Segel and Follette (J. Thorac. Cardiovasc. Surg. 106: 811-22, 1993) studied the preservation of the isolated rat heart with cycles of 5 or 10 minutes of perfusion followed by 25 minutes of no perfusion. They evaluated the results by measuring the ability of the heart to work during 4 hours of in vitro perfusion after storage for a total of 12 hours. They concluded: “the intermittent perfusion-preserved hearts had significantly lower post-preservation contractile function (left ventricular systolic pressure, peak rates of left ventricular pressure development and relaxation, peak aortic flow rate, stroke work, and peak power) and higher left ventricular end-diastolic pressure compared with the control [non-preserved] group.” Clearly, these studies do not provide convincing evidence for the clinical utility of intermittent perfusion for preservation in excess of 24 hrs, they describe techniques that would not be practical to implement clinically, and they provide results that are not convincing because the rat models used do not reflect the dynamics of heart transplantation in large species such as dogs or humans.

Some studies have tried to correlate the effect of intermittent perfusion with biochemical changes in preserved organs. Tani and Neely (Am. J. Physiol. 258: H354-361, 1990) showed, using the isolated rat heart, that intermittent perfusion attenuated both the increase in intracellular sodium during ischemia and the rise in calcium during reperfusion. Several studies have shown the advantages of intermittent perfusion on myocardial adenine nucleotide and creatine phosphate (so-called “high energy” phosphates, or HEP) status during or after hypothermic storage. Dyszkiewicz et al. (Materia Medica Polona 22: 147-152, 1990) stored the dog heart for 24 hours at 0.5° C. with intermittent perfusion at 4, 8, and 12 hours. They found that myocardial ATP content was better preserved by intermittent perfusion. Lockett et al studied in rabbit hearts the status of HEP using phosphorus magnetic resonance scanning (P MRS) (Transplant International 8: 8-12, 1995). The hearts were stored for 24 hours, then reperfused with a 6-8° C. cardioplegic solution. A 30-minute cold reperfusion raised myocardial creatine phosphate (PCr) levels somewhat, but there was no comparison to controls and there was no functional testing of the hearts, rendering the study nearly meaningless. In an orthotopic canine heart transplantation model, Ohtaki et al (J. Heart Lung Transpl. 15: 269, 1996) reported that myocardial HEP levels and tissue histology were greatly improved by 60 minutes of 4° C. reperfusion with oxygenated University of Wisconsin solution (commercially available as VIAPSAN™ (Barr Laboratories, Woodcliff Lake, N.J.) following initial flushing with and subsequent 12 hours of cold immersion storage in the same solution. However, left ventricular pressure two hours after transplantation was only 76% of control pressure, and not that much better than the pressure developed by hearts stored without the bout of intermittent perfusion (52% of control). The rate of pressure development was only 83% of the control rate, again not dramatically better than the rate obtained after simple cold storage (68%). These results do not motivate application to clinical heart preservation due to the relatively modest and inadequate gains obtained at the cost of a prolonged intermittent perfusion technique that would be costly and risky to perform manually.

The specific mechanism by which intermittent perfusion works is, to an extent, speculative. It has long been appreciated that the following factors probably contribute to the effectiveness of intermittent perfusion: (1) the provision of critical substrates and oxygen leading to higher myocardial chemical energy resources, (2) the removal of accumulated metabolic byproducts (including, for example, hydrogen ions), (3) the reversal of passive ion leaks, (4) the reduction of cellular and organelle swelling and calcium accumulation, and (5) the reversal of various catabolic processes, including the salvage of adenine nucleotide catabolites prior to their conversion to membrane-permeable and free radical generating forms such as inosine and hypoxanthine. It has also been suggested that depletion of ATP to a critical level may be a key factor in reaching an irreversible condition. However, no rigorous explanation for the beneficial effects of intermittent perfusion currently exists, and such an explanation will presumably require years of additional study to elucidate. Unfortunately, the lack of an established predictive biochemical index for the effectiveness of intermittent perfusion has inhibited the development of practical means for intermittent perfusion that can greatly extend the useful period of large mammal organ preservation.

The prior art, therefore, suggests that intermittent perfusion might be a reasonable research avenue for developing an improved method of organ preservation, but it provides no reliable information about how to carry out intermittent perfusion in the most advantageous way or about how to improve IP, nor does it even provide convincing evidence that intermittent perfusion can be improved sufficiently to be of practical value for the preservation of organs, particularly for prolonged preservation of sensitive organs like the heart, lung, liver, and pancreas. A common problem associated with many past studies has been the use of undemanding or unconvincing methods for assessing the viability of the preserved heart or the use of small animal models that are insufficiently comparable to human hearts. To develop cardiac preservation techniques with obvious direct promise for clinical application, it is imperative that a large animal orthotopic cardiac transplant model be used to assess the efficacy of the storage method. For this reason, a large portion of past observations has little clear clinical relevance. Until now, no reliable long-term method has ever been established or even proposed. Further, it is not clear how the frequent bouts of intermittent perfusion required by most past methods could be done in a practical way.

The inspiration for the present invention was based, on the one hand, on the clear need for transcending the restrictive 4 to 6 hour limit on human cardiac cold storage times and, on the other, on some positive though grossly inadequate results made on rat hearts. One of the present inventors found (Banker M C, Hicks G L, Wang T, “Multi-dose cardioplegia as a strategy for twenty-four hour functional and metabolic preservation of the cardiac explant,” Surg. Forum 43: 246-248 (1992) that short cardioplegic intermittent perfusion at 25° C. minimized perfusion-induced edema and quickly repleted ATP after both 10 and 17 hours of storage at 0° C. Rat hearts stored with no perfusion at 0° C. for 24 hours failed to recover any function after reperfusion, but hearts that received only two 2-minute intermittent perfusions (at 10 and 17 hours or 10 and 20 hours of storage) recovered 50% of prestorage function. More frequent perfusion with intervals shorter than 10 hours was undesirable. (Zhu Q, Yang X, Claydon M A, Hicks G L, Wang T, “Twenty-four hour intermittent perfusion storage of the isolated rat heart: The effect of perfusion intervals on functional preservation,” J. Heart Lung Transpl: 13: 882-890 (1994). In a third study, it was found that 30 to 80 mm Hg provided the optimal intermittent perfusion pressure for the isolated rat heart, viability being compromised at lower (20 mm Hg) or higher (100 mm Hg) intermittent perfusion pressures. Overall, 60 and 70 mm Hg pressure provided the best preservation of cardiac function (Zhu Q, Yang X, Claydon M A, Hicks G L, Wang T. “Twenty-four hour intermittent perfusion storage of the isolated rat heart: II. Effect of perfusion pressure on functional preservation,” J. Surg. Res. 61: 159-164 (1996).

These results with rat hearts could not have allowed the present inventors to predict that it would be possible to store large animal hearts for over 40 hours with excellent recovery using methods of intermittent perfusion that are practical to deploy clinically, yet these rat heart studies have, surprisingly, led on to just this accomplishment. It is the object of the present patent to describe a new and unique mammalian heart preservation device and method that significantly and unexpectedly extend the viable life of explanted hearts.

### SUMMARY OF THE INVENTION

The present invention provides an intermittent perfusion method involving protocols, solutions, and devices that are capable of extending the viable life of an explanted mammalian heart for up to at least approximately 49 hours. The system that implements the method includes a perfusion chest of approximately the same size as the standard ice chests that are currently being used to store and transport human organs. The perfusion chest of the present invention, however, contains all of the mechanical and electrical components needed to automatically perfuse the heart in accordance with the perfusion procedure. The invention includes a novel and surprisingly effective perfusion method which extends the viability of a mammalian heart, as described below.

Therefore, in one aspect the present invention provides methods of extending the viable life of an explanted mammalian heart. The methods include storing the heart in a cold environment of less than 10° C., perfusing the heart with warm perfusate of between 10° C. and 39° C. for a period of approximately five (5) minutes to thirty (30) minutes, after storing the heart in the cold environment for a period of up to approximately twenty-four (24) hours.

In another aspect the present invention provides methods of extending the viable life of an explanted mammalian heart. The methods involve storing the heart in a cold environment of less than 10° C., perfusing the heart with warm perfusate of between 10° C. and 39° C. for a period of approximately five (5) minutes to thirty (30) minutes, after storing the heart in the cold environment for a period of up to approximately twenty-four (24) hours; perfusing the heart with cold perfusate of less than 10° C.; and continuing to store the heart in the cold environment for a period of up to approximately seventeen (17) hours after the period of cold perfusion.

In another aspect the present invention provides methods of extending the viable life of an explanted mammalian heart. The methods involve storing the heart in a cold environment of less than 10° C.; perfusing the heart with warm perfusate of between 10° C. and 39° C. for a period of approximately five (5) minutes to thirty (30) minutes; after storing the heart in the cold environment for a period of up to approximately twenty-eight (28) hours; perfusing the heart with cold perfusate of less than 10° C.; perfusing the heart with the warm perfusate for approximately five (5) minutes to thirty (30) minutes; after storing the heart in the cold environment for a period of up to approximately seventeen (17) hours after perfusing the heart with the cold perfusate; and perfusing the heart with cold perfusate of less than 10° C.

In various embodiments of either of the above methods the perfusate can be UR-IP Solution, UR-IP-Flush Solution, CP-11H, CP-11EB, or UW Solution. The cold environment can be at a temperature at or near the melting point of ice. The temperature of the warm perfusate can be between 20° C. and 34° C. In one embodiment the temperature of the warm perfusate is between 15° C. and 37° C. Any of the above methods can further involve transplanting the heart. In one embodiment the heart is transplanted within approximately four (4) hours after the warm perfusion of step (d).

In another aspect the present invention provides a device for preserving an explanted mammalian heart. The device includes an intermittent perfusion chest having a warm compartment and a cold compartment; an organ reservoir disposed within the cold compartment; a perfusate bag disposed within the warm compartment; a warm perfusate tube operably connected at one end to the perfusate bag and, at the tube's other end, to the organ reservoir; a cold perfusate tube operably connected at one end to the perfusate bag and, at the tube's other end, to the organ reservoir; an extensible air bag adjacent to the perfusate bag; an air pump operably connected to the air bag; an effluent bag disposed within the warm compartment or an effluent reservoir; and an effluent tube operably connected at one end to the effluent bag and, at the tube's other end, to the organ reservoir.

In one embodiment the devices can include a controller which controls the operation of the air pump, which supplies air to the air bag, causing the air bag to extend and to, in turn, compress the perfusate bag. The devices can also include a perfusate ball or pinch valve which allows warm perfusate to flow within the warm perfusate tube to the organ reservoir. In one embodiment the devices have a perfusate ball or pinch valve which allows cold perfusate to flow within the cold perfusate tube to the organ reservoir. The perfusate bag can contain perfusate, and the cold compartment can contain ice. In one embodiment of the device the cold compartment contains approximately 23-24 liters of accessible space. In its extended configuration, the perfusate bag can contain approximately 12 liters of perfusate.

### BRIEF DESCRIPTION OF DRAWINGS

FIG. 1 illustrates a front perspective view of the perfusion system.

FIG. 2 illustrates a front perspective view of the perfusion chest with portions of the perfusion chest removed in order to disclose components inside the perfusion chest.

FIG. 3 illustrates a perspective view of the perfusate module and perfusate cage.

FIG. 4 illustrates a perspective view of the perfusate cage.

FIG. 5 illustrates a perspective view of the extensible perfusate air bag.

FIG. 6 illustrates the perfusion system interior, without the perfusion module.

FIG. 7 illustrates a typical sealing construction for the chest lid against the outer edges of the intermittent perfusion chest walls and clearance between the open spaces within the perfusion chest and the underside of the lid, and showing contact between the wall conveyances and the lid and between the organ container and the lid.

FIG. 8 is a flow chart showing the operation of the microprocessor control routine.

FIG. 9 shows the regeneration of high energy phosphates and pH as a function of intermittent perfusion time.

FIG. 10 shows the speed with which intermittent perfusion raised temperature in both intermittent perfusion bouts in this experiment. This figure also suggests that cooling using a cold perfusate flush can cool hearts at rates similar to the rate of warming displayed in the figure. Extrapolating to a human heart, one liter of cold flushing should reduce the heart temperature to less than 10° C. after a warm intermittent perfusion near room temperature. Human hearts average around 350 grams in mass. At a flow rate of 0.8 ml/g/min, which is a high estimate, such an average heart will perfusate at a rate of 280 ml/min, and one liter of cold flush solution would last slightly less than 4 minutes. From the graph, 4 minutes is long enough to change temperature by 13° C. Therefore, if the starting temperature is 23° C., a human heart could be cooled to about 10° C. using around 1 liter of cold perfusate.

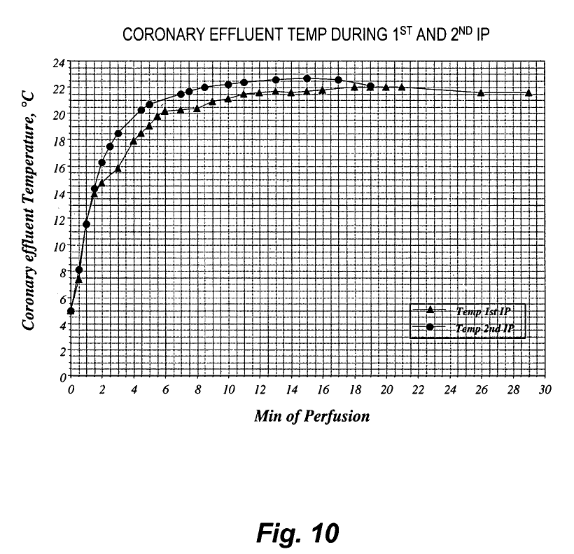

FIG. 11 shows the flow rates during the second IP. Until around 3 minutes or so of intermittent perfusion, the flow rate is sluggish, after which the flow increases and thereafter remains steady. A steady coronary flow may have been established earlier than 3 min. The initial slow flow was because the coronary system, the coronary sinus, and the right atrium have to be filled before coronary effluent will run off from the pulmonary artery. The restoration of a steady flow is another criterion for the length of IP, since until flow becomes steady, it cannot be assumed that the intermittent perfusion perfusate has reached all regions of the heart. Note also that the flow rates for the dog heart, even after they have become steady, do not reach 0.8 ml/g/min.

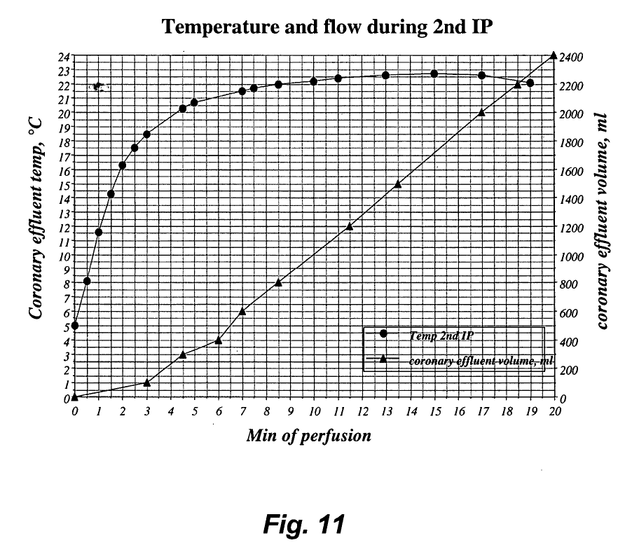

### DETAILED DESCRIPTION OF THE INVENTION

The invention comprises a new perfusion method and system that extends the viability of a mammalian heart to approximately forty-nine (49) hours after it is collected. The method successfully preserves a mammalian heart, for up to a total period of approximately forty-one (41) hours by utilizing only a single bout of intermittent perfusion lasting between approximately five (5) minutes and thirty (30) minutes, and is able to extend the heart's preservation for up to a total period of approximately forty-nine (49) hours by utilizing only two (2) bouts of intermittent perfusion, with each bout lasting between approximately five (5) minutes and thirty (30) minutes.

More specifically, the method of preserving a mammalian heart for up to approximately forty-one (41) hours includes preserving the heart by static (non-perfusional) cold storage at or near the melting point of ice (i.e., approximately 0-10° C. or at about 0-5° C.), for a time period of up to approximately twenty-four (24) hours, then b) administering a single bout of warm oxygenated perfusion (at approximately 10-30° C., or 20-25° C., and pO₂ of 140-760 mmHg or 500-760 mmHg) for approximately five (5) minutes to thirty (30) minutes, and c) cooling the heart to a temperature of below about 10 C, d) storing the organ at a temperature between about 0 C and 10 C or 0 C and 5 C for an additional period of approximately seventeen (17) hours, and e) implanting the organ.

The method of extending the mammalian heart's viable life for up to a total period of approximately forty-nine (49) hours includes preserving the organ without perfusion at or near the melting point of ice (0-10° C. or 0-5° C.) for a period of up to approximately twenty-eight (28) hours, administering a first bout of warm oxygenated perfusion (10-30 C or 20-25 C with a pO2 of 140-760 mmHg or 500-760 mmHg) for approximately five (5) minutes to thirty (30) minutes, cooling the organ to below 10° C. but above about 0° C., continuing to maintain the organ at or near the melting point of ice (0-10° C. or 0-5° C.) for an additional period of approximately seventeen (17) hours, administering a second bout of warm oxygenated perfusion as above for approximately five (5) minutes to thirty (30) minutes, cooling the heart to less than 10° C., holding the heart at about 1-10° C. for approximately four (4) to five (5) hours, and transplanting the heart.

The temperature of the perfusate used in connection with the present invention must be “warm.” Preferably the temperature should be between 10° C. and 39° C., or more preferably between 15° C. and 37° C., and still more preferably between 20° C. and 34° C.

The ability to delay the initiation of perfusion for up to twenty-eight (28) hours after the organ is first collected is a major advantage of the invention. Without wanting to be bound by any particular theory, it is believed that this advantage is conveyed in part by the resuscitative effects of warm perfusion, which can reverse injury that is otherwise believed to be fatal. This may allow hearts held in UW solution, which provides no more than 4-6 hours of viable cold storage under ordinary conditions, to be recovered after longer than 46 hours of storage, and even after 24 hours or more of cold storage in UW solutions. This resuscitative potential is wholly unpredictable from current methods of perfusing or cold-storing organs prior to implantation. Current technology teaches that hearts and other similarly sensitive organs such as the pancreas and lung will simply be dead and not useable after approximately six (6) to twelve (12) hours after collection. Therefore, the ability to recover a heart after its assumed “shelf life” has expired is an unexpected result and not predictable based upon the current state of the art of organ preservation. Secondly, it is believed that the ability to delay the first bout of warm perfusion to up to twenty-eight hours of cold storage is also greatly facilitated by the use of the perfusates (UR-flush and UR-IP) described herein (see below). At any given period of storage, the use of UR-flush and UR-IP is believed to provide superior results to those results that are achievable with any other known preservation formulas for the heart.

The ability to delay the first bout of perfusion for up to twenty-eight (28) hours does not require that the first bout of perfusion be delayed that long, because the heart can also be revived by intermittent perfusion after shorter storage times. As a result, if the user is ready to transplant an organ after only 18 hours, for example, the user can induce intermittent perfusion to occur at, for instance, 17 hours of preservation, and store the heart for a brief period after intermittent perfusion until the surgeon is ready to transplant the heart. In various other embodiments, the user can induce intermittent perfusion to occur at 5 hours or 10 hours or 15 hours or 20 hours, or any number of hours up to about 28. As another example, if the user obtains a heart preserved in UW solution, it can be submitted to IP after 4-6 hours of cold storage in UW solution to maximize its recovery after a total of 24 hours of total storage time. Generally, the organ should be resuscitated from four (4) to twenty (20) hours following the last episode of warm perfusion. This flexibility overcomes the problem of adapting the intermittent perfusion method to the actual, unpredictable working needs of transplant teams, whose time constraints for transplantation will be different for every organ transplanted.

The above-described invention is more effective and more practical than prior art methods. Furthermore, the method of the current invention has been adapted for use as part of a portable device which is similar to and may be used in the same fashion as a standard ice chest which is currently being used by organ transplant surgical and transplant teams. Thus, it is a further object of the present invention to describe a practical device for carrying out the described intermittent perfusion method.

While the present inventors do not desire to be bound by any theory, they believe the new intermittent perfusion technique described here is effective for several reasons.

First, warm perfusion is most effective at restoring metabolism and thereby restoring physiological normalcy of the preserved organ. In the case of the heart, intermittent perfusion under cardioplegic conditions allows the heart to institute self-repair without the requirement of supporting a circulatory load. The simultaneous requirement to institute repair and to support a circulatory load, which is what normally happens when the organ is transplanted but when intermittent perfusion is not used before transplantation, exceeds the energy producing capacities of the preserved heart, such that self-repair cannot occur effectively, and the heart fails. In this regard, warm perfusion is preferably carried out using an oxygenated perfusate. In the device described herein, the oxygen can be supplied when the perfusate is packaged, so that the user does not necessarily have to oxygenate the perfusate at the time of use. This can overcome a significant issue of practicality for some end users, although it is believed that most end users will not object to providing oxygenation of the perfusate on site, while the heart is being procured. In the device described herein, the oxidation of reduced substances in the perfusate by contact with oxygen over the several months of storage of the oxygenated perfusate prior to use can be avoided by compartmentalizing the oxidizable substrates separately from the non-oxidizable components of the perfusate. Similarly, any otherwise-fragile components of the perfusate can be protected in this or a similar compartment.

Second, intermittent perfusion can induce tissue edema. Repeated bouts of intermittent perfusion produce more and more tissue edema, which is damaging to the preserved organ. The inventors have discovered that by limiting intermittent perfusion to one or two bouts, the problems of tissue edema can be reduced to acceptable limits. Prior art has assumed that intermittent perfusion would be ineffective unless many bouts of intermittent perfusion were used, but the use of many (greater than 2 or at most 3) bouts of intermittent perfusion is both counterproductive and unnecessary according to the present invention. More than three bouts of intermittent perfusion were attempted by prior investigators on the basis of the use of such a pattern during conventional in vivo cardioplegia treatments, but this tradition is inappropriate for long-term cardiac preservation and is contrary to the teachings of the present invention.

Third, the present inventors have followed the reconstitution of various biochemical indices of cardiac energy reserves as a function of intermittent perfusion time and have found that intermittent perfusion durations of less than 5 minutes are ineffective at restoring high energy phosphates (creatine phosphate, ATP) and normalizing tissue pH, whereas intermittent perfusion durations of over 30 minutes reach a point of diminishing return. Therefore, the inventors have defined the most advantageous duration of the intermittent perfusion bout as lasting between about 5 and about 30 minutes. Surprisingly, intermittent perfusion for 20 or for 30 minutes yields no substantial increase in tissue edema compared to intermittent perfusion for 5 minutes, which again is unpredictable over the prior art.

Although the intermittent perfusion method of the present invention does not require the utilization of any particular intermittent perfusion solution, the preferred solutions for use in this invention are solutions that have been optimized for this purpose. A range of such optimized solutions have been shown to be effective. For example, the inventors have found that commercially-available University of Wisconsin Solution (sold under the trade name of VIASPAN® by Barr Laboratories, Pomona, N.Y.), can be effective in the invention. However, several new and effective solution formulas have been proven to be particularly effective in the method of the invention. These formulas and the detailed methods that have been experimentally shown to be effective in demonstrating the utility of the present invention are provided below in the Experiments.

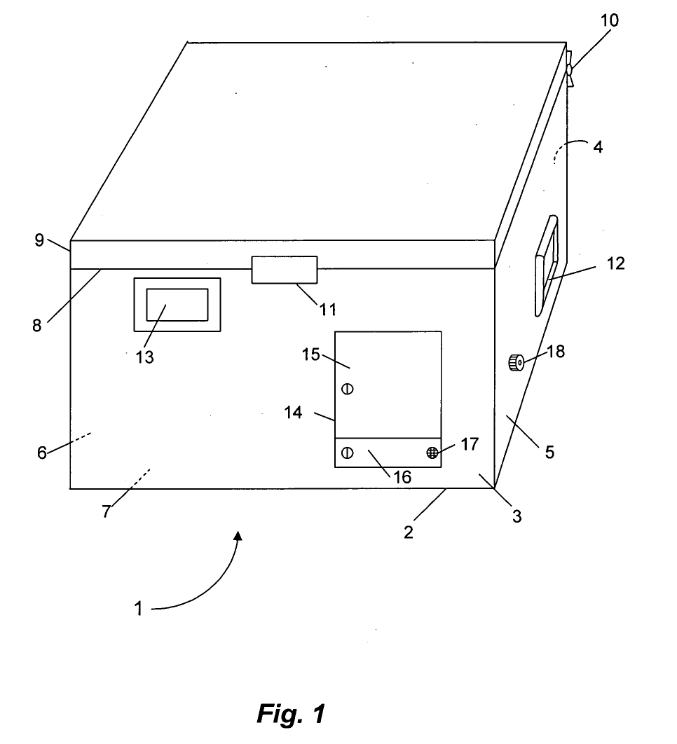

A detailed description of the device of the present invention is described in conjunction with FIGS. 1 through 7 as follows.

A front perspective view of the perfusion system 1 of the present invention is illustrated in FIG. 1. The system 1 includes a rectangularly shaped intermittent perfusion chest 2, having an insulated front and back wall 3 and 4, two insulated right and left side walls 5 and 6, an insulated bottom member 7, and a top end 8. Each of the insulated walls and bottom member has an outside panel and an inside panel, with insulation disposed between the panels. An insulated perfusion chest lid 9 is attached to the top end 8 of the perfusion chest 2 by utilizing a pair of hinges 10 which are attached to the top portion of the outside panel of the back wall 4 and to a back edge of the lid 9. A latch 11 is provided which enables the lid 9 to be secured against the top end of the perfusion chest 2 and permits the lid 9 to be rotated open, and a pair of handles 12 are attached to the outside panels of the perfusion chest's two side walls 5 and 6.

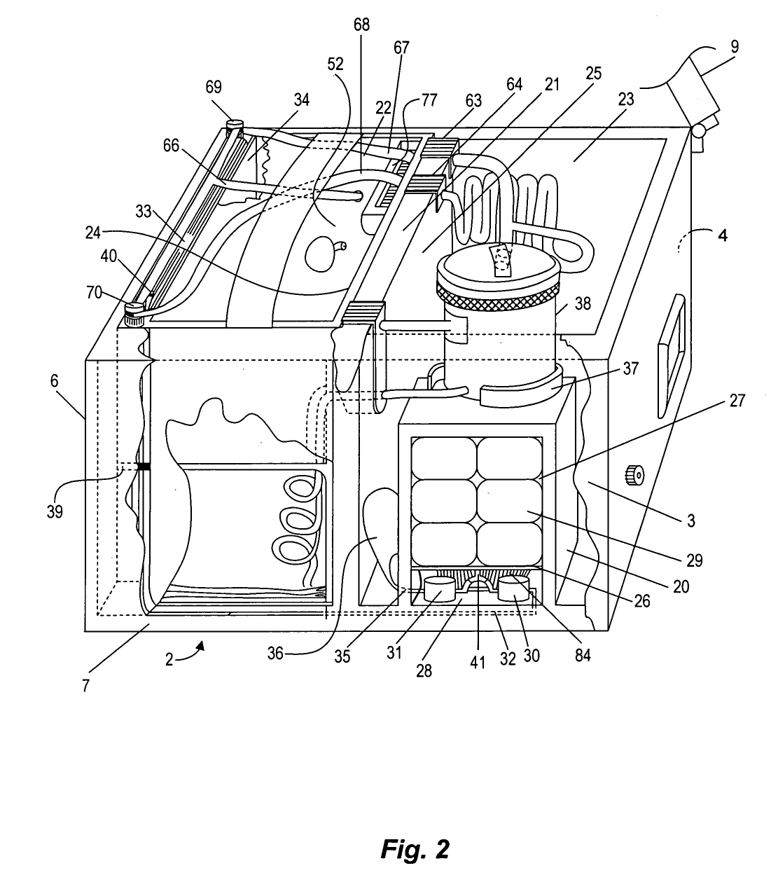

The outside panel of the perfusion chest's front wall 3 contains a controller panel 13 which is used to operate a programmed microprocessor controller which controls a perfusion schedule. A suitable controller, which includes the wall panel display is the ST-IE Panel-Touch Controller™ with Enhanced Configuration, available from Mosaic Industries, Inc., Newark, Calif. A service panel 14, also located on the front wall's outside panel, contains a battery access panel 15 and a pump access panel 16. The battery access panel 15 provides access into a rectangularly shaped battery and pump housing 20 (shown in FIG. 2), containing approximately three (3) to six (6) lantern-type batteries 29 (FIG. 2), which are sufficient to power the perfusion system, which will be described in more detail in connection with FIG. 2. Similarly, the pump access panel 16 provides access into that portion of the battery and pump housing 20 containing a pneumatic pump 84, as shown in FIG. 2. A filtered air vent 17 is disposed within the pump access panel 16, and provides a supply of outside air to the pump 84. And, a drain port 18, disposed through the right side wall 5 and adjacent to the bottom member 7, is provided in order to drain water from the perfusion chest 2.

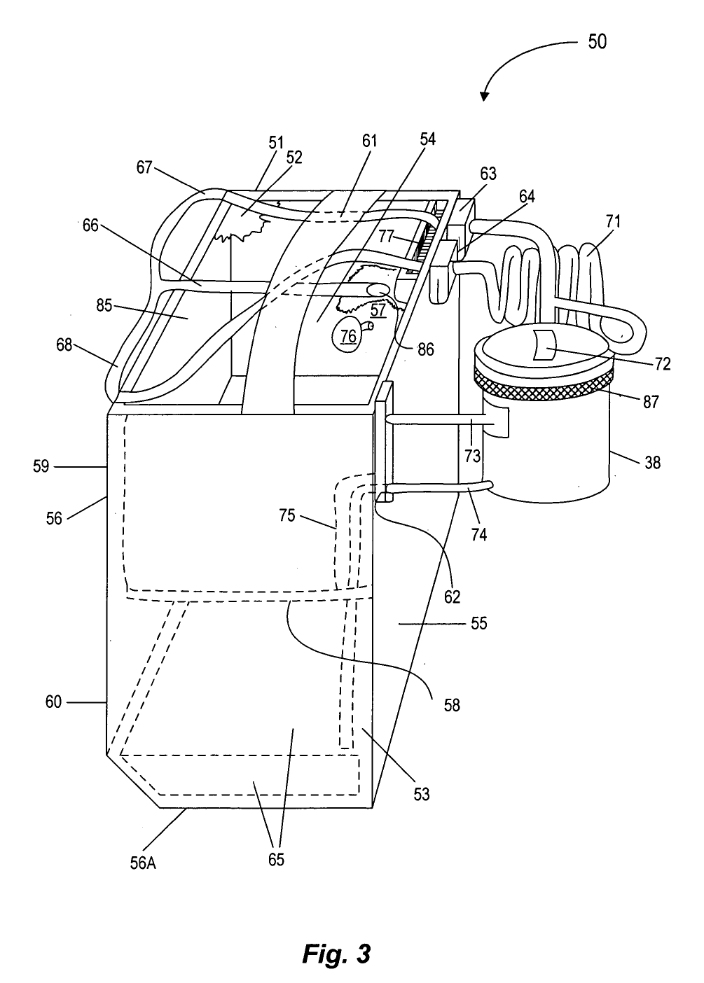

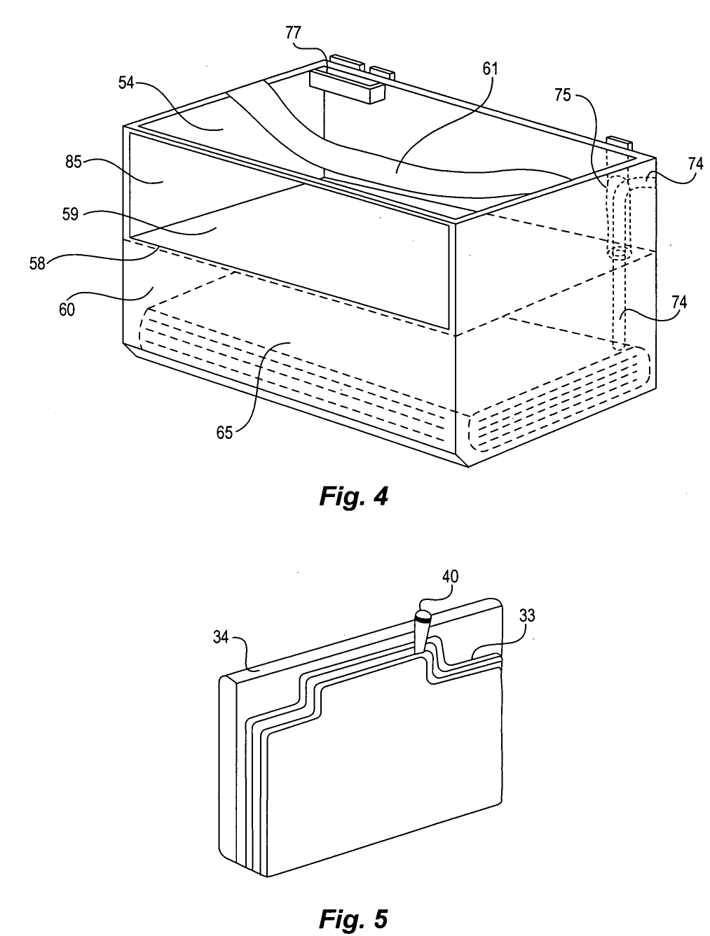

FIG. 2 illustrates the perfusion chest 2, with its lid 9 opened and with portions of its front wall 3 removed in order to show the components inside the perfusion chest 2. The inside portion of the perfusion chest 2 is separated by an insulated lateral wall 21 which extends from the front wall 3 to the back wall 4 and defines a warm compartment 22 on the left side of the perfusion chest 2, and a cold compartment 23 on the right side. The lateral wall 21 has a warm panel 24 adjacent to the warm compartment 22, and a cold panel 25 adjacent to the cold compartment 23, with insulation material disposed between the two panels. In general, the warm and cold compartments 22 and 23 of the perfusion chest 2 contain a perfusate module 50 (illustrated in FIG. 3) and contain the mechanical and electrical components which operate the module 50 in order to perfuse a mammalian organ. Initially, however, FIG. 2 will be primarily discussed as it relates to the chest's components which operate the perfusate module 50 and the details of the module 50 will be presented further in connection with a description of FIG. 3 and FIG. 4.

As shown in FIG. 2, the rectangularly shaped battery and pump housing 20, briefly discussed above, has an open space within the housing 20, and the housing 20 is disposed within the front, bottom portion of the cold compartment 23 such that the housing's open space is effectively insulated from the cold compartment 23. This insulation is accomplished by attaching the housing's bottom end to the inside panel of the perfusion chest's bottom member 7, and the housing's front end is attached to the inside panel of the perfusion chest's front wall 3. The housing 20 is sized such that its position within the cold compartment 23 leaves a predetermined volume of approximately 23-24 liters of open space within the cold compartment 23. As will be described in more detail below in connection with a description of the operation of the invention, the amount of open space is specified so that a sufficient quantity of ice and cold water can be stored within the cold compartment 23, which further enables the present invention's perfusion method to successfully preserve the organ for unexpectedly long periods of time.

A horizontal battery platform 26, disposed within the battery and pump housing's open space, separates the space into a battery compartment 27 located above the platform 26 and a pump compartment 28, located below the platform 26. Approximately six (6) lantern-type 6-volt batteries (such as Duracell MN918 batteries) 29 are disposed within the battery compartment 27 and supported by the platform 26. If three (3) batteries are used, one (1) of the batteries runs the controller, and two (2) batteries in series run all other components. However, if extended operational times are needed, up to three (3) additional batteries maybe used. A pneumatic pump 84, pneumatic lines 32, 35, and 41, and pneumatic valves 30 and 31 are also disposed within the pump compartment 28 and bottom member 7. The pneumatic pump 84 is operationally connected to the inlet ports of the pneumatic valves 30 and 31 by means of the common tube 41. Valve 31 allows air supplied by pneumatic pump 84 to be directed to balloon 36. The pneumatic valve 30 allows air supplied by pneumatic pump 84 to be directed to air tube 32. Air tube 32 passes from the pump compartment 28, and through an opening in the inner panel of the perfusion chest's bottom member 7, then passes horizontally through the space between the inside and outside panels of the perfusion chest's bottom member 7, then passes vertically between the panel of the perfusion chest's left side wall and the left side of the perfusate module. The tube terminates in a junction with an extensible air bag 33, which is disposed within the warm compartment 22. The air bag 33 is constructed such that it is capable of retracting back to its starting, unextended position upon release of internal pressure and release of internal air, without significant sagging. Preferably, the bag 33 is supported internally by a rigid but extensible framework, akin to a bellows. This is important both for supporting a pressure application plate 34 and for preventing it from canting when it applies pressure to the wall of a perfusate bag 52 (FIG. 2). Because the perfusate bag 52 contains perfusate, it will have a higher internal pressure at the bottom than at the top. A steady pressure applied by the pressure application plate 34 to perfusate bag 52 will therefore tend to result in more movement of the upper bag wall than of the lower bag wall unless canting of the pressure application plate 34 is prevented. Air bag 33 can also be a rigid bellows.

Returning to the pump compartment 28, the outlet port of the balloon flow-through valve 31 is operationally connected to one end of a balloon air tube 35. The balloon air tube 35 passes from the pump compartment 28, through a vertical wall of the battery and pump housing 20, and the tube's other end is connected to a balloon 36, disposed within the cold compartment. The balloon air tube's passage through the battery and pump housing is sealed by means of bonding between the tube and the wall material at the time of manufacture, or by other means known in the art, so that the cold water within the cold compartment does not leak into the open space within the housing. The balloon 36 is used to prevent the level of floating ice from falling too low within the cold compartment 23, which would otherwise result as ice melts and air formerly held within the unmelted ice moves upward in the cold compartment, allowing the ice level to move lower. Preferably, the balloon 36 is periodically injected with sufficient air to prevent the water level from falling significantly. For example, approximately 1.8 liters of air every twelve (12) hours of organ storage will keep the water level approximately constant in the cold compartment 23 even given a relatively high rate of heat inleak into cold compartment 23 assuming that air comprises about 40% of the volume of crushed ice.

The cold compartment 23 also contains an organ reservoir retainer ring 37 which is preferably permanently attached to the horizontal top surface of the battery and pump housing 20, and is used to hold an organ reservoir 38, which will be described in connection with the perfusate module 50 described in FIGS. 3 and 4 below.

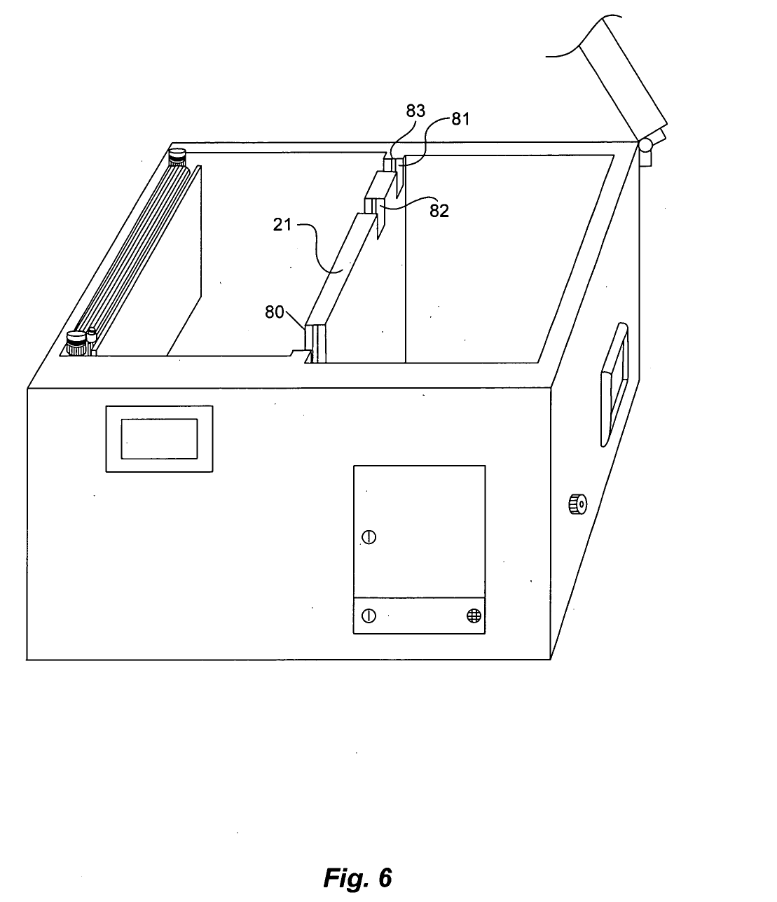

Turning to the warm compartment 22, the extensible air bag 33 and the integral, generally vertical, pressure plate 34 (visible through a cutaway view through bag 52) are disposed within the warm compartment 22, with the air bag 33, as shown in FIG. 2, in its unextended configuration. An isolated view of the unextended air bag 33 and its pressure plate 34 is also shown in FIG. 5. In the air bag's extended configuration, the air bag 33 forms a generally rectangular shape, having a vertical end surface which is attached to the top portion of the inside panel of the perfusion chest's left wall 6. The opposite vertical end of the air bag is attached to the inside surface of the pressure plate 34, and the outside surface of the pressure plate 34 faces a perfusate bag 52, which will be described below. The air bag 33 and its plate 34, in an unextended configuration, rest on a narrow, horizontal air bag platform 39 which is attached along one longitudinal edge to the inside panel of the perfusion chest's left wall 6. FIGS. 2 and 5 also illustrate that the top of the extensible air bag 33 contains an air release valve 40, which when manually loosened permits air to escape from the air bag 33 in its extended configuration, allowing the air bag 33 to be compressed into its unextended configuration. Alternatively, the air pump 84 can be run in reverse at the end of a preservation run to automatically deflate air bag 33 and automatically retract air bag 33 into its compact, non-extended shape, or this action can be accomplished by a second air pump installed in the air pump space specifically for this purpose. Similarly, pressure is released within balloon 36 within the cold compartment at the end of the preservation run to lower the cold water and ice level and thereby expose the organ container so that the lid can be removed as described below and the organ can be retrieved. In addition, an overpressure relief valve can be included in the pneumatic system to ensure that the pressure cannot exceed a predetermined limit if this limit is not otherwise enforced by the inability of the selected pneumatic pump to deliver a pressure in excess of the desired pressure. A desirable perfusion pressure of the organ during intermittent perfusion is 30-80 mmHg, and more preferably 40-60 mmHg. The applied pressure can be measured anywhere within the part of the pneumatic system that is devoted to propelling the perfusate. In FIG. 2, a pressure microsensor can be located for example, at a point in the common air line 41 located before it branches to supply the on-off valves 30 and 31 that lead to air bag 33 and balloon 36.

The perfusate module 50 and a perfusate cage 51 are shown in FIG. 3, and FIG. 4 illustrates an isolated view of the cage 51.

Referring to FIG. 3 and FIG. 4, the cage 51 is in the shape of a rectangular box having a front and back cage panel 53 and 54, a right side and left side cage panel 55 and 56, a bottom cage panel 56A, and an open top end 57. The cage contains a rectangularly shaped, horizontal perfusate platform 58 (FIG. 4) which is attached to the inside surfaces of the cage panels and is located approximately midway between the cage's open top end and its bottom panel, thereby defining upper and lower warm compartments 59 and 60, respectively. The left side cage panel 56 further contains a rectangular opening 85 which extends between the perfusate platform 58 and the cage's open top end 57 and between the cage's front and back panels 53 and 54. The lower portion of the left side cage panel may have a taper intended to facilitate insertion of the perfusate module into the intermittent perfusion chest. The top of the cage 57 has a tote strap 61 which is attached at one end to the top portion of the cage's front panel 53 and at the strap's other end to the top portion of the cage's back panel 54.

An effluent wall conveyance 62 is attached to the outside surface of the right cage panel 55, and is located adjacent to the panel's upper front comer. Similar warm and cold perfusate wall conveyances 63 and 64, respectively, are also attached to the outside surface of the right cage panel 55, and are located adjacent to the panel's upper rear comer. The function of the wall conveyances is to permit perfusate or effluent to flow between the warm compartment and the cold compartment by passing through the insulated lateral wall 21 separating these two compartments, but without permitting leakage of air, water, or heat between these two compartments. As a result, the wall conveyances constitute insulated plugs through which perfusate or effluent can pass freely.

The perfusate module 50 generally comprises a rectangularly shaped perfusate bag 52 (shown mostly cut away in FIG. 3), a rectangularly shaped effluent bag 65, the cage 51, the organ reservoir 38, and associated tubing and other structures. The perfusate bag 52 is disposed within the upper warm compartment 59. At the beginning of a perfusion schedule, the perfusate bag 52 is completely filled with approximately 12 liters of perfusate, which causes the bag 52 to substantially fill the upper warm compartment 59, resting on the perfusate platform 58. In this position, the left side of the perfusate bag 52 is adjacent to the outside surface of the pressure plate 34. Preferably, the perfusate to be used with the present invention is UR-IP Solution, the composition of which is disclosed herein; alternatively, UR-Flush Solution, CP-11H, CP-11EB, or VIASPAN® (UW Solution) may be used. The composition of VIASPAN® is known in the art, and the compositions of UR-IP Solution, UR-Flush, CP-11H, and CP-11EB are disclosed herein. The top of the perfusate bag 52 contains a perfusate outlet port 86, which is integrally connected to a common perfusate tube 66. The common perfusate tube 66 generally extends laterally across the top of the perfusate cage 51, to the left side cage panel 56, where the tube 66 separates into a warm tube 67 for conveying perfusate during warm perfusions and a cold tube 68 for conveying perfusate during cold perfusions. A first segment of the warm perfusate tube 67 extends parallel to the top portion of the left side cage panel, to a first flow control pinch valve 69 depicted in FIG. 2 and located adjacent to the cage's back side panel 54, where the warm perfusate tube 67 passes through the first pinch valve 69. An acceptable pinch valve for the present invention is a Cole Parmer P-98301-00 valve. A second segment of the warm perfusate tube 67, continuous with the first segment, extends from the pinch valve 69 to the organ reservoir 38, where it generally extends through the wall of the organ reservoir 38 to form an integral docking site within the organ reservoir 38 to be used to connect the cannula of a cannulated organ to the warm perfusion tube 67. The warm perfusion tube's second segment also passes through and is bonded to the warm perfusate wall conveyance 63 so that cold water does not pass from the cold compartment 23 into the warm compartment 22, and warm air from the warm compartment 22 does not escape into the cold compartment 23.

Similarly, a first segment of the cold tube 68 leads to a second flow control pinch valve 70 located opposite from the first flow control valve 69 and passes through the pinch valve 70 (FIG. 2). A second segment of the cold tube 68, continuous with the first segment, extends from the pinch valve to a junction with the warm tube 67, adjacent to the outside surface of the organ reservoir wall. The cold tube's second segment also passes through and is sealed within the cold perfusate wall conveyance 64, in order to prevent cross-contamination as described above.

A heat exchange unit 71 is formed within that portion of the cold tube's second segment, which extends between the cold perfusate wall conveyance 64 and the organ reservoir 38. Preferably, the heat exchange unit 71 comprises a series of approximately parallel “U” shaped bends in the cold tube that form either a uni- or multi-layered plane. The heat exchange unit 71, as will be described in more detail below, stores the volume of perfusate required for a single cold flush and allows reduction of the temperature of the perfusate it contains to a temperature at or near the melting point of ice. The heat exchange unit 71 is positioned within the cold compartment such that the unit will be enmeshed within the layer of ice contained within the cold compartment 23 at the level of the organ reservoir 38.

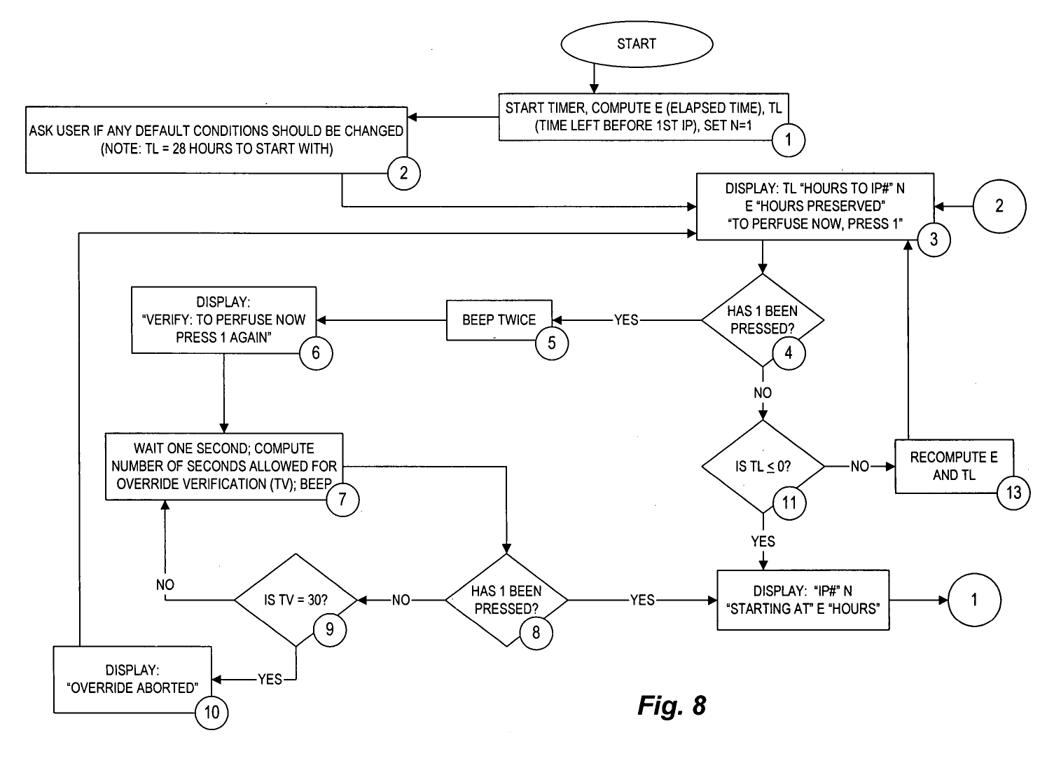

The perfusate module 50 also includes the organ reservoir 38. Preferably, the organ reservoir 38 consists of a cylindrically shaped housing having a cylindrical wall, a circular reservoir lid and circular reservoir bottom. The reservoir lid preferably screws down or snaps onto the top of the organ reservoir 38, forming an airtight seal on a collar 87 extending radially outward from the wall of the organ reservoir 38, such that the screw threads of the organ reservoir lid and the wall of the organ reservoir 38 cannot be exposed to melted ice and thereby be contaminated. A brief external rinse of the organ reservoir lid with sterile saline prior to opening the organ reservoir lid ensures safety in removing the lid without contamination of the organ inside the organ reservoir. Further assurance can be obtained, if desired, by containing a second lid within the first, with a similar design, the presence of which essentially guarantees sterile opening of the organ reservoir, as illustrated in FIG. 7. A handle 72 is attached to the top surface of the reservoir lid in order to assist a user in installing and removing the perfusate module or in preventing the lid from touching non-sterile surfaces when the lid is removed from the organ reservoir to admit the organ into the organ reservoir.

The inside of the organ reservoir contains organ-supporting means which are well-known in the art, such as a soft mesh floor, a sling or “hammock,” a tilted or non-tilted “V-shaped or “U”-shaped platform, or may contain gauze or other sterile protective material inserted by the surgeon, to provide support to the organ and to prevent movement of the organ during transport.

A horizontal brace member 73 extends between the organ reservoir 38 and the perfusate cage 51. One end of the brace member 73 is attached to the outside surface of the reservoir's wall, adjacent to the reservoir lid, and the brace's other end is attached to the outside surface of the top portion of the effluent wall conveyance 62.

A rectangularly shaped, extensible effluent bag 65 is disposed within the bottom portion of the perfusion cage's lower warm compartment 60, and the bottom of the bag 65 rests on the bottom cage panel 56A. In the bag's extended configuration, the bag 65 may extend to occupy the entire lower warm compartment 60. An effluent tube 74 is integrally attached at one end to an outlet opening within the organ reservoir 38 and the tube 74 sealably passes through the lower portion of the effluent wall conveyance 62, and then through the interior portion of a cylindrically shaped shield 75, which is attached at one end to the inside vertical surface of the perfusate cage and at the other end to the top surface of the perfusate platform. The effluent tube 74 then passes through an opening in the perfusate platform, and then downwardly through the lower warm compartment 60 where the effluent tube 74 is connected at its other end to an effluent inlet port disposed within the top surface of the effluent bag 65. This connection is made in such a way that the effluent tube 74 is unable to kink closed as the effluent bag 65 fills.

Referring back to FIG. 2, a user inserts the perfusate module 50 into the perfusion chest 2, by simply grasping the tote strap 61 and lifting the module 50 above the top end of the open chest, and lowering the module 50 into the chest 2, with the cage 51 disposed within the warm compartment 22 and the organ reservoir's bottom seated within the retainer ring 37 on top of the battery and pump housing 20.

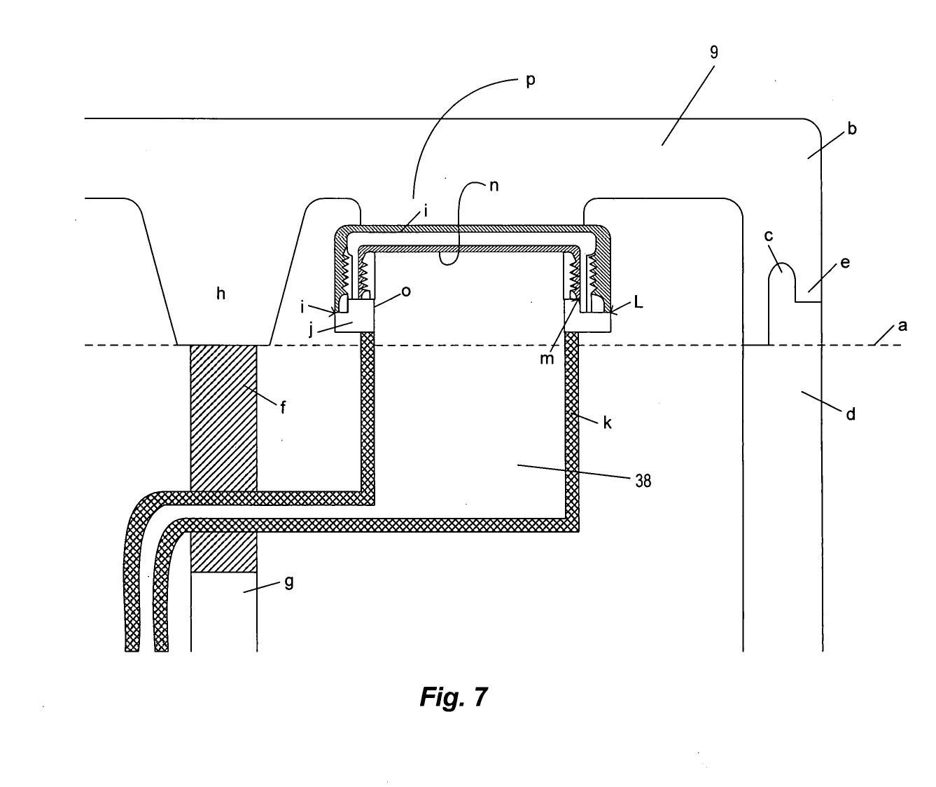

As illustrated in FIG. 6, the insulated lateral wall 21, which separates the perfusion chest into the cold and warm compartments, contains an effluent slot 80 located within the top portion of the lateral wall 21, and contains warm and cold perfusate slots 81 and 82, also located within the top portion of the lateral wall 21. When the module 50 is lowered into position, the effluent slot 80 is positioned such that the effluent wall conveyance 62 fits into the effluent slot 80. Similarly, the warm and cold perfusate slots 81 and 82 are positioned such that the warm and cold perfusate conveyances 63 and 64 fit into their respective perfusate slots. The wall conveyances are all sealably positioned by the weight of the perfusate module forcing them into tight contact with their mating wall slots and by the further downward pressure supplied by contact between the flat upper surfaces of the wall conveyances with a flat underside of the lid of the intermittent perfusion chest, as illustrated in FIG. 7. The composition of the wall conveyances can include a deformable surface layer that forms a seal when squeezed against the wall slot inner surfaces as described. In addition, the wall slots can contain protrusions 83 visible in FIG. 6 that concentrate the force generated by contact between the wall conveyances and the slot surfaces to a smaller surface area, thus magnifying the local compression of the deformable material surface layer of the conveyances and ensuring a tighter seal.

The method of the invention preferably involves the use of an oxygenated warm perfusate. Therefore, the perfusate within perfusate bag 52 is preferably oxygenated. In order to preserve an elevated oxygen tension in the perfusate until its time of use, the bag is preferably adequately impermeable to oxygen. Several flexible oxygen-impermeable materials are known in the art that can usefully compose the perfusate bag or an outer coating or sheath on the outside wall of perfusate bag can be used in order to maintain oxygen tension within perfusate bag 52. Such materials include both metal foil compositions and nonmetallic films used, for example, for the long-term storage of dehydrated or sealed foodstuffs. However, because the perfusate will generally comprise some oxidizable components that may be subject to damage during prolonged storage in the presence of an elevated oxygen tension, perfusate bag 52 also has appended to it a smaller concentrate bag 76 (FIG. 3) that contains oxidizable perfusate constituents that are prevented from flowing into perfusate bag 52 by a thin, burstable diaphragm. When the perfusate module is loaded into the intermittent perfusion chest, concentrate bag 76 is manually squeezed to burst the burstable diaphragm and release the contents of concentrate bag 76 into perfusate bag 52. Mixing between the added materials and the contents of the perfusate bag 52 is then accomplished by a combination of manual physical motion of the upper surface of perfusate bag 52 and unaided diffusion over the long periods (up to at least 28 hours) available prior to the first intermittent perfusion, as well as by motions of the perfusate bag as the intermittent perfusion chest and its contents are transported. Similarly, perishable perfusate ingredients that can be stabilized in a specialized environment (such as by isolation as a pure substance concentrate, for example) can also be enclosed within separate concentrate bags if necessary and released into the perfusate bag as described above. Because common perfusate line 66 and first warm perfusate tubing segment 67 and first cold perfusate tubing segment 68 would be the sites of oxygen leakage as well, at least these elements of the perfusate module are also preferably oxygen impermeant. A useful definition of “oxygen impermeant” is that the material retains most added oxygen for a period not shorter than the projected lifetime of the perfusate module before it is used. If oxygenation is provided at the factory, a typical lifetime for such a perfusate module is assumed to be 3 to 6 months or longer. If oxygenation is provided by the organ procurement organization, the pertinent lifetime for defining “oxygen impermeant” may be 4 to 30 hours depending on when the oxygenation is performed relative to the time the organ will be subjected to warm IP. The walls 53, 55, and 54 as well as the platform 58 of cage 51 and pressure applicator plate 34 will also effectively reduce the surface area of the bag in contact with air and thereby slow the loss of oxygen.

Also shown in FIGS. 2, 3, and 4 is bag deflector barrier 77. In the embodiment shown, this barrier 77 creates a space between perfusate bag 52 and the right wall 55 of the perfusate cage 51, so as to facilitate passage of warm perfusate tubing and cold perfusate tubing to their respective wall conveyances, by analogy with shield 75 used to prevent collapse of the effluent return line as it passes from its point of entry in the perfusate cage to its point of entry into the lower warm compartment of the perfusate cage.

FIG. 7 describes additional sealing detail of the perfusion chest lid 9. Fill line a is the reference point for calculating the volumes within the warm and cold compartments but, as illustrated, additional air space exists above the warm and cold compartments and under the chest lid b. FIG. 7 illustrates a typical sealing configuration found between ice chest walls and their mating lids in the art, involving a protuberance c in wall d and a raised edge e that is higher than the edge that defines fill line a. This model sealing mechanism is acceptable within the present invention. Additional sealing mechanisms are as follows.

First, the wall conveyances f must have upper surfaces that are flush with the upper surfaces of insulating wall g between the warm and cold compartments to prevent leakage over wall g. To seal the top of wall g and the tops of conveyances f, protrusion h of lid b is designed to apply downward pressure on these structures, or on deformable layers thereon, when the lid b is closed and latched in place. Sealing structures such as those depicted to seal the outer wall may also be employed to seal the inner wall g and the conveyances f to the upper lid b.

FIG. 7 also provides more detail of one preferred sealing mechanism for the lid of organ reservoir 38. In this embodiment, outer lid I screws down on collar j, which is integral with or firmly attached to wall k of organ reservoir 38, thereby forming an external seal at circumferential point “L” When outer lid I is rinsed with sterile saline, only an infinitesimal amount of contaminant, located at the outside limit of point L, will endanger the sterility of the contents of the organ chamber. None of this contaminant, however, will contact point m, which is the sealing point for inner lid n on elevated internal rim o of collar j. Therefore, all points within inner lid n will remain sterile, and removing inner lid n will not contaminate the interior of the organ reservoir.

Finally, if desired, protuberance p of chest lid b can be disposed so as to press upon lid I when chest lid b is closed. This will supply extra positional stability of the organ reservoir 38 within the intermittent perfusion chest 2, although much stability will already be. provided by brace 73 and by retainer ring 37. However, another function of said contact between protuberance p and the organ reservoir can be included if desired by users of the invention. Radially extending collar j could provide circumferential contact points for a hollow cylindrical variation of protuberance p such that sealing of protuberance p against collar j would prevent contact of melted ice with even the outside lid I at point L. This would further guarantee sterility, if needed to reassure users of the invention. It would also further stabilize organ chamber 38 against lateral motion.

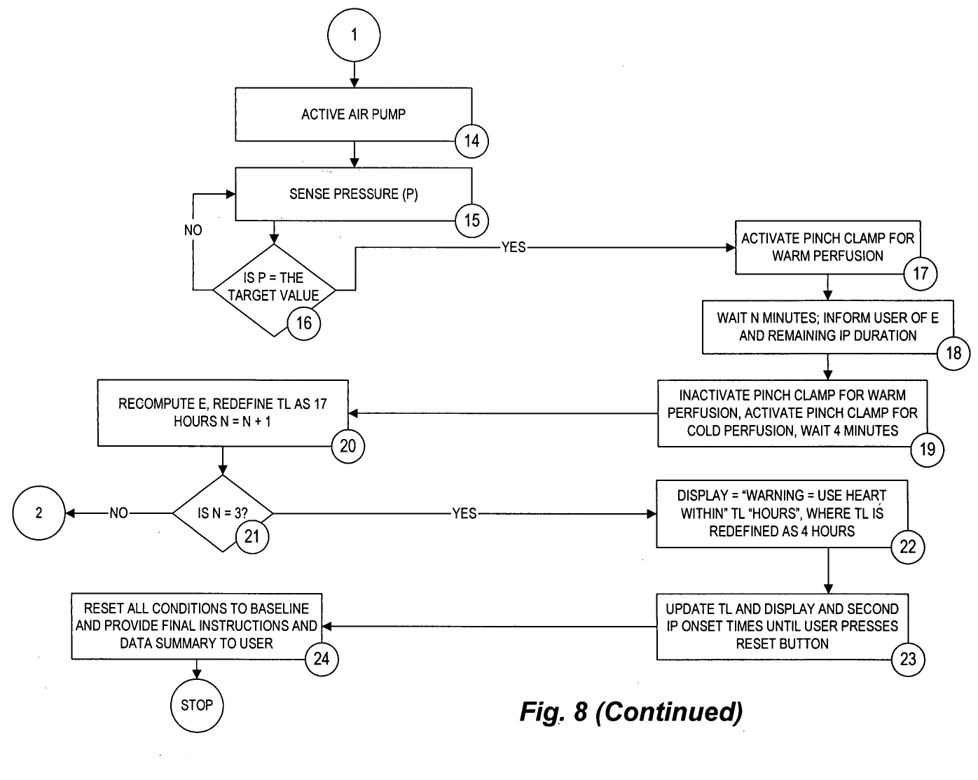

A flow chart of the operation of the controller is given in FIG. 8. However, it is also possible to operate the invention manually, with no controller, though this is not preferred.

In operation, the perfusion system 1 of the present invention is used in a manner which is similar to conventional usages. The transplant coordinator lifts up the perfusate module 50 and its integral cage 51, using the tote strap 61, and lowers the module 50 and cage 51 into the perfusion chest 2 such that the cage 51 is positioned within the warm compartment 22, and the bottom of the organ reservoir 38 is seated within the organ retainer ring 37. Once the module 50 and cage 51 are in place, the left side of the perfusate bag 52 will be adjacent to the extensible air bag's pressure plate 34, and each of the wall conveyances will be disposed within their respective slots within the lateral insulated wall 21, which separates the warm and cold compartments 22 and 23.

Next, the coordinator squeezes the substrate bag 76 which releases oxidizable substrate into the perfusate within the perfusate bag 52. Warm and cold perfusate tubes 67 and 68 are, respectively pulled into the first and second pinch valves 69 and 70, and ice is added to the cold compartment 23 in order to cover the heat exchange unit 71.

At this point, the surgeon cannulates the organ, flushes it free of blood, and connects the organ cannula to the cannula dock within the organ reservoir 38. The surgeon uses a sterile syringe full of perfusate in order to displace any air introduced into the cannula or into the dock.

The coordinator then replaces the organ reservoir lid in a sterile fashion, additional ice is added to completely fill the cold compartment, and the lid is closed and secured using the latch. Finally, the coordinator activates the perfusion system 1 by pressing a start button on the controller panel 13 to initiate the perfusion schedule. All operations are then automatic until the organ is ready for transplantation or until a specific total preservation time is entered that is shorter than the default preservation time.

Operation of the perfusion system 1 of the present invention is automatically controlled by a controller which is activated by a clock in accordance with the perfusion method of the invention. The controller and clock are both positioned within the front wall 3 of the perfusion chest 2 and adjacent to the controller panel 13. When the controller is activated by the clock, in order to start a bout of warm perfusion, the controller activates the pneumatic pump 84, the pneumatic valve 30, and the first perfusion pinch valve 69. The pump 84 pumps air into the air tube 32, which in turn causes air to flow into the extensible air bag 33. As the air bag extends laterally, the air bag's pressure plate 34 applies a lateral force against the side of the perfusate bag, which in turn causes perfusate to flow through the warm perfusion tube, through the open pinch valve 69, through the warm perfusate wall conveyance 63, through the organ reservoir wall, through the cannula and into the heart's coronary arteries. Ultimately, the perfusate flows out of the heart, as effluent, and the effluent is collected at the bottom of the organ reservoir 38, where it flows out of the reservoir through the effluent tube 74 and into the effluent bag 65 within the warm compartment 22. In a preferred embodiment, the controller continues the warm perfusion for about five (5) minutes to thirty (30) minutes.

Similarly, if the controller is activated to perform a cold perfusion, the controller again activates the pump 84 and the pneumatic valve 30, but in this instance, the controller activates the second perfusion pinch valve 70. Once again, the pump 84 pumps air into the air tube 32, which in turn causes the air bag 33 to apply a lateral force against the perfusion bag, which causes perfusate to flow through the cold perfusion tube and ultimately through the heart. Prior to entering the heart, however, the perfusate is cooled by the heat exchange unit 71, immersed in ice within the cold compartment 23. The cold effluent collects in the bottom of the organ reservoir 38 and empties into the effluent bag 65. When the perfusion schedule is complete, the heart is stored in organ reservoir 38 until it is removed and transplanted, and the perfusate module 50 is simply lifted from the system 1 and discarded.

The controller is programmed, upon activation, to perfuse the organ in accordance with the perfusion method which administers a bout of warm perfusion at twenty-eight (28) hours of cold storage, followed by a bout of cold perfusion, then a second bout of warm perfusion at forty-five (45) hours of cold storage followed by a bout of cold perfusion. The organ is then ready for transplant preferably within the next four (4) hours, or after approximately forty-nine (49) hours of storage. This forty-nine (49) hour storage schedule, however, may be modified by the transplant coordinator, depending upon the actual storage time required. For example, if the heart arrives at the recipient site at any time after the first bout of cold perfusion and prior to the second warm perfusion, the heart is ready to be removed from the perfusion chest and prepared for transplantation. Similarly, if the heart arrives prior to the first bout of perfusion, the controller panel prompts the user to manually activate a single cycle of warm and cold perfusion, after which the heart is ready to be transplanted.

The user may also elect to override the forty-nine (49) hour, two-bout schedule and activate the forty-one (41) hour, one bout of perfusion schedule. In this instance, the controller perfuses the heart after twenty-four (24) hours of storage, followed by a cold bout of perfusion, and the heart may then be stored for up to seventeen (17) more hours, prior to implantation, for a total of forty-one (41) hours of preserved storage. Again, the user may change the schedule if the total potential storage times are not needed. If the heart arrives at its destination prior to the first bout of perfusion, the operator may manually activate a single cycle of warm and cold perfusion, after which the heart is ready for transplantation.

FIG. 8 presents an example flow chart showing appropriate control steps of the controller program and how it can allow for operation of the perfusion system 1 by a transplant coordinator. After the heart has been placed in the perfusion chest 2, and the lid has been closed, the user activates the system 1 by pressing a start button on the controller panel 13. In step 1, a default program starts to implement the present invention's forty-nine (49) hour perfusion schedule. An elapsed time variable “E” begins recording the total elapsed storage time, and another variable “TL” calculates the time left before the first intermittent perfusion at an elapsed time of twenty-eight (28) hours. Variable “N” is set to one, which represents the number of perfusions. At step 2, the program displays a query asking the user if the default program conditions should be changed. Based on the user's inputs, the total hours remaining until the first intermittent perfusion, the total hours of elapsed storage time, and the number of IPs to be performed are displayed in step 3. In addition, if the user desires to override the schedule and initiate a bout of perfusion, the user is prompted by an indicator on the panel screen: “TO PERFUSE NOW, PRESS 1.”

If the user elects to initiate a perfusion by pressing 1, the program passes control from step 4 to step 5, where the controller issues a beeping sound twice, and at step 6, the panel display prompts the user to verify, by pressing “1” again, that a bout of perfusion should be initiated. At step 7, the program waits a predefined time “TV” (e.g., thirty (30) seconds) for the user to enter a verification. If at step 8, the program determines that the user has elected to start a bout of perfusion, then the display shows that perfusion number “N” (i.e., 1) is starting at an elapsed period of time, (i.e., “E” hours). On the other hand, if the user fails to verify the start of perfusion, within the time limit at step 9, the intermittent perfusion override is aborted at step 10, and control returns to step 3, where the display screen returns to the programmed perfusion schedule.

Returning to step 4, if the user does not elect to override the schedule, the program, at step 11, continues to monitor the time left (“TL”) before the next bout of perfusion is due. If the time left is less than or equal to zero (0) (i.e., no time is left), the program displays that perfusion number “N” (i.e., 1) is starting at an elapsed period of time (i.e., “E” hours). If the time left is still greater than zero (0) (i.e., time is still remaining before the next perfusion), the program at step 13 continues to compute the elapsed time (“E”) and the time left (“TL”).

Once the programmed controller determines that it is time to administer a bout of intermittent perfusion, the controller activates the air pump 84 at step 14. The pump includes a pressure sensor, which at step 15, senses the air pressure maintained by the pump. At step 16, the controller determines whether the air pump 84 is producing a predetermined target pressure, and if it is not, control is returned to step 15, where the sensor continues to sense the air pressure. If the target air pressure is being maintained, the controller, at step. 17 activates the first pinch valve 69 for warm perfusion. At this point, the system 1 begins perfusing the heart with warm perfusate and continues to do so for a preprogrammed time period as indicated at step 18. Then at step 19, the controller inactivates the pinch valve 69 and activates second pinch valve 70 for cold perfusion, which lasts for a preprogrammed time period of four (4) minutes.

At step 20, elapsed time (“E”) is recomputed, time left (“TL”) is set at seventeen (17) hours, which is the period of time left before the second perfusion, and the number of perfusions (“N”) is increased by 1 (i.e., N now equals 2). At step 21, the programmed controller determines the value of “N.” If N≠3 (i.e., the second perfusion has not been administered), control returns to step 3 and the process continues as described above where the user may initiate a perfusion before the second perfusion is automatically scheduled to occur after seventeen (17) hours, or the user may allow the second perfusion to occur automatically.

If at step 21, however, the program determines that the second warm and cold perfusion have already been administered, the program, at step 22, displays a warning to the user that the heart must be used within a specified period of time, e.g., within the next four (4) hours (i.e., “TL” 4). At step 23, the program continues to display the time remaining (“TL”) and displays the first and second perfusion onset elapsed times until the user presses a reset button on the controller panel 13. Pressing the reset button causes the program, at step 24, to reset all perfusion conditions to baseline values and the controller provides final instructions and a data summary to the user.

The intermittent perfusion method of the present invention, and the utilization of specific perfusate solutions, is further illustrated by the experiments set forth below, which are in no way intended to limit the scope of the invention, but are intended to provide detailed example of the utility and range of the present invention.

Experiment 1: Preservation of the Canine Heart for 40 Hours Using Two Bouts of IP

Five dog hearts were stored for a total of 40 hours. The hearts were cardioplegically arrested using CP-11EB (see formula below) and stored by immersion at 0° C. for 40 hours, with perfusion at 20 and 36 hours of storage with a 25° C. cardioplegic solution (CP-11EB) at a perfusion pressure of 55 mm Hg for 5 minutes. As is evident in Table 1 (below), hemodynamic and contractile function when these hearts were transplanted after 40 hours of storage, and after weaning from cardiopulmonary bypass (CPB), were normal and remained stable without inotropic support for at least 6 hours.

TABLE I
HEMODYNAMIC AND CONTRACTILE FUNCTION OF
TRANSPLANTED CANINE HEARTS PRESERVED FOR 40 HOURS,
AFTER WEANING FROM CARDIOPULMONARY BYPASS (CPB)

| Hours | Heart rate | Systolic | Diastolic | +dP/dt | −dP/dt |
|---|---|---|---|---|---|
| off | (beats/ | pressure | pressure | (mm | (−mm |
| CPB | min) | (mm Hg) | (mm Hg) | Hg/sec) | Hg/sec) |
| 1 | 145 ± 20 | 105 ± 22 | 42 ± 5 | 986 ± 204 | −684 ± 350 |
| 2 | 129 ± 12 | 102 ± 19 | 46 ± 7 | 1035 ± 297 | −503 ± 208 |
| 3 | 98 ± 5 | 108 ± 12 | 47 ± 7 | 1070 ± 212 | −415 ± 90 |
| 4 | 96 ± 9 | 109 ± 6 | 48 ± 9 | 1134 ± 246 | −458 ± 106 |
| 5 | 97 ± 6 | 114 ± 11 | 50 ± 8 | 1134 ± 349 | −553 ± 201 |
| 6 | 96 ± 4 | 111 ± 6 | 53 ± 8 | 1031 ± 152 | −350 ± 52 |

Donor hearts stored for 40 hours without intermittent perfusion did not develop normal rhythm and could not support the recipient off bypass. Therefore, intermittent perfusion was needed for the success obtained. Edema induced by intermittent perfusion was negligible (1.4% weight gain at 20 hours and 5.8% at 36 hours).

Experiment 2: Biochemical Definitions of the Optimal Intermittent Perfusion Time

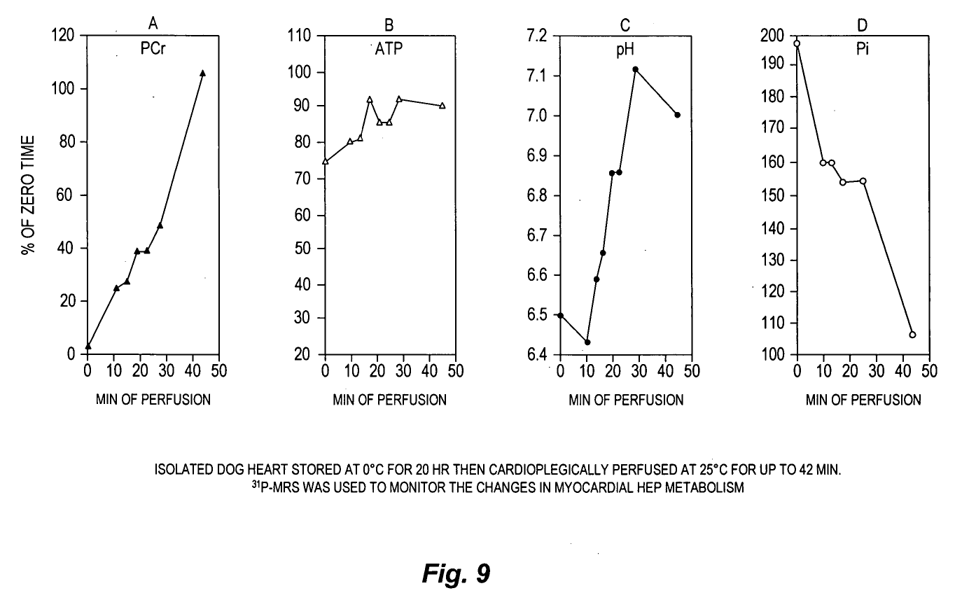

Experiment 1 was conducted using 5 min intermittent perfusion bouts. In order to better define ideal intermittent perfusion perfusion times, the effect on PCr and ATP levels of varying the period of 25° C. cardioplegic perfusion in dog hearts stored at 0° C. for 20 hours was studied using P-MRS at 62.5 mmHg. As illustrated in FIG. 9A, at the onset of perfusion, PCr was only 3% of the prestorage level. As perfusion progressed, PCr rose linearly with time and was over 100% after 42 minutes. ATP level was 72% at the beginning and gradually reached 90% by 13 minutes of perfusion (see FIG. 9B). Intracellular pH was acidic and did not change for the first 10 minutes. It then rose and reached the physiologic range by 25 minutes (see FIG. 9C). Intracellular inorganic phosphate (Pi) levels declined steadily with warm perfusion time (see FIG. 9D). FIGS. 9A through 9D show changes in PCr and ATP levels, intracellular pH, and inorganic phosphate levels in isolated dog heart stored at 0° C. for 20 hours then cardioplegically perfused at 25° C. for up to 42 minutes. P-MRS was used to monitor the changes in myocardial HEP metabolism. These results imply that reperfusion times of 5-60 min, and more preferably of 5-30 minutes, will be optimal for IP. However, it was also possible that longer intermittent perfusion would produce intractable problems from edema. Subsequent experiments were devoted, in part, to determining the feasibility and efficacy of intermittent perfusion lasting longer than 5 minutes.

Experiment 3: Preservation for up to 46.5 Hours Using 2 Bouts Lasting Longer than 5 Minutes and Using CP-11EB/CP-11H

On the basis of the results given in Experiment 1 and in FIG. 9, preservation periods exceeding 40 hours were investigated. CP-11EB is a preferred solution for use as a flush solution for hearts in the current invention. CP-11H is the same solution, but with 6% High Molecular Weight hydroxyethyl starch (Hetastarch) [B. Braun Medical, 2525 McGaw Avenue, Irvine, Calif. 92614]. Other molecular weight preparations of hydroxyethyl starch (HES), such as the “pentafraction” used in the commercial VIASPANR^{R}® solution (Barr Laboratories) or the “pentastarch” ingredient being used in the PENTALYTE® solution (BioTime, Inc.) will also be effective in the invention. In principle, the inclusion of HES should reduce edema and help to combat damage caused by intermittent perfusion lasting longer than 5 minutes. However, in two experiments involving storage for only 36 hours, it was found that, surprisingly, the use of CP-11H as a flush solution followed by CP-11H as an intermittent perfusion solution led to gross edema and failure to successfully wean the dog off of bypass. However, flushing with an HES-free solution (CP-11EB) followed by intermittent perfusion with CP-11H at 62.5 mmHg was successful in 5 out of 5 transplants involving hearts preserved for 40 to 46.5 hours. The results are given in the following table.

| | Experiment Number | | | | |
|---|---|---|---|---|---|
| | 1 | 2 | 3 | 4 | 5 |
| Total preservation time (hr) | 42.5 | 40 | 43.5 | 45.5 | 46.5 |
| Sex of Donor | M | M | M | F | F |
| Time at which 1st IP was done (hr) | 20 | 20 | 20 | 20 | 22 |
| Duration of First IP (minutes) | 30 | 20 | NR | 20 | 40 |
| Time at which 2nd IP was done (hr) | 36 | 36 | 36 | 36 | 36 |
| Duration of 2nd IP (minutes) | 7.5 | 20 | NR | 20 | 18 |
| Starting Heart Weight (g) | 125 | 149 | NR | 162 | 147 |
| Weight gain/starting weight × 100% | −1% | 11% | NR | 14% | 28% |
| Heart Rate (beats/minute) | 106 | 110 | 105 | 118 | 105 |
| Systolic Pressure (mmHg) | 111 | 110 | 103 | 115 | 104 |
| Diastolic Pressure (mmHg) | 40 | 58 | 54 | 50 | 69 |
| Ejection Fraction (%) | 60 | 55 | 60 | 50 | 58 |

(NR = Not Recorded)

The formulas for CP-11EB and CP-11H are as follows:

CP-11EB contains NaCl 111.5 mM, KCl 14 mM, glucose 7 mM, mannitol 10 mM, MgSO₄ 15 mM, KH₂PO₄ 1.2 MM, NaOH 6.2 mM, butanedione monoxime 7.5 mM, HEPES free acid 10 mM, CaCl₂ 0.28 mM, and EDTA 0.02 mM, pH adjusted to 7.5 at room temperature with NaOH, Osmolality (calculated) 307 mOsm.

CP-11H is CP-11EB containing 6% hydroxyethyl starch (Hetastarch).

Variants of CP-11EB and CP-11H will also be effective in which all components are allowed to vary within a tolerance of about plus or minus 25% provided that the final osmolality also remains within about plus or minus 25% of the osmolality of the unmodified solutions.

Experiment 4: Preservation of the Canine Heart for 41 Hours Using a Single Bout of IP

To further define the invention, and to evaluate the efficacy of modifications to our flush and intermittent perfusion solutions, we attempted to reverse a longer period of cold ischemic injury by using a 30-minute bout of intermittent perfusion at 62.5 mmHg at 24 hours followed by transplantation at 41 hours with no second bout of intermittent perfusion. In this experiment, a solution called UR-Flush Solution was used to flush blood from the heart and preserve it for the 24 hours that preceded IP, and a second solution, UR-IP Solution, was used to accomplish the IP step and was left in the heart during subsequent cold storage. This protocol was successful, as demonstrated by the data below.

| Parameter | Before Preservation | | After Preservation | |
|---|---|---|---|---|
| Heart Rate | 132 +/− 2 | beats/min | 88 +/− 13 | bpm |
| Systolic | 129 +/− 6 | mmHg | 135 +/− 10 | mmHg |
| Pressure | | | | |
| Diastolic | 72 +/− 5 | mmHg | 51 +/− 7 | mmHg |
| Pressure | | | | |
| dP/dt | 801 +/− 138 | mmHg/min | 1443 +/− 369 | mmHg/min |
| −dP/dt | −505 +/− 200 | mmHg/min | −461 +/− 38 | mmHg/min |
| Weight | Before IP: 171 | grams | After IP: 176 | grams |

This heart was so good that it only needed two shocks after reimplantation to reverse fibrillation. Amazingly, the heart went into sinus rhythm without pacing or inotropic support. The weight gain was only 3%, and the flow rate was 0.6 ml/g/min, which is good.

The intermittent perfusion solution used in this experiment was modified to include aprotinin (Trasylol, from Bayer Corporation, 400 Morgan Lane, West Haven, Conn.) (see amounts given below) and to better maintain pH. A 5 to 7.5 mM tricine buffer was included, whose pKa of 7.8, in conjunction with the pKa of HEPES of 7.5, maintained pH surprisingly well after initial setting of the pH of the solution to 7.8 prior to preservation. The specifics are as follows.

| Minutes After Onset of IP | |
|---|---|
| at 24 Hrs of Preservation | pH of Effluent |
| 5 | 7.16 |
| 10 | 7.41 |
| 15 | 7.58 |
| 20 | 7.65 |
| 25 | 7.71 |
| 30 | 7.80 |

Thus, 10 minutes of intermittent perfusion were sufficient to restore pH to the physiologic range, and 30 min of intermittent perfusion provided an effluent pH equal to the pre-preservation pH, thus protecting the heart against the subsequent storage until transplantation was done at 41 hours.

The solutions used in this experiment are as follows:

Formula for UR Flush Solution (or UR-Flush, used successfully to prepare the heart in the 1-IP, 41 Hr Preservation experiment):

| | | | Grams/n liters | | |
|---|---|---|---|---|---|
| Chemical | mM | M.W. | n = 1.0 | n = 2.0 | n = 4.0 |
| NaCl | 100.00 | 58.5 | 5.85 | 11.70 | 23.40 |
| KCl | 14.00 | 74.6 | 1.04 | 2.09 | 4.18 |
| Glucose | 10.00 | 180 | 1.80 | 3.60 | 7.20 |
| Mannitol | 7.00 | 182 | 1.27 | 2.55 | 5.10 |
| MgSO₄ + 7 H₂O | 15.00 | 246.5 | 3.70 | 7.40 | 14.79 |
| KH₂PO₄ | 1.20 | 136.1 | 0.16 | 0.33 | 0.65 |
| Adenosine | 0.10 | 267 | 0.03 | 0.05 | 0.11 |
| Aprotinin (ml) | 200 | 10000 | 20 | 40 | 80 |
| | (KIU/L) | | | | |
| HEPES | 10.0 | 238.3 | 2.38 | 4.77 | 9.53 |
| Free Acid | | | | | |
| Tricine | 5.0 | 179 | 0.90 | 1.79 | 3.58 |
| NaOH | 6.20 | 40 | 0.25 | 0.50 | 0.99 |
| BDM | 7.50 | 101.1 | 0.76 | 1.52 | 3.03 |
| CaCl₂ | 0.28 | 147 | 5 ml* | 10 ml* | 20 ml* |
| EDTA | 0.02 | 372 | 5 ml* | 10 ml* | 20 ml* |

BDM is butanedione monoxime.
*Supplied as a stock solution, the stock solution being used in 5, 10, and 20 ml quantities per 1, 2, and 4 liters, respectively, the stock concentrate containing 4 mM disodium EDTA, or 1.49 grams/liter of stock solution, and containing 56 mM CaCl₂, or 8.23 grams/liter of stock solution.

The ionic composition of the UR Flush Solution is:

Na: ˜106.2 mM; K: ˜15.2 mM; Mg: ˜15 mM; Ca: ˜0.28 mM; and

Cl: ˜114.6 mM; the final calculated osmolality is ˜316 milliosmolal (mOsm) and the final pH is set to 7.8 at room temperature.

Variants of UR-Flush will also be effective in which all components are allowed to vary within a tolerance of about ±25% provided the final osmolality also remains within about ±25% of the preferred ˜316 mOsm.

Formula for UR-IP Solution (or UR-IP, or UR intermittent perfusion solution, used successfully for IP in the one-IP, 41-Hr Preservation experiment):

| | | | Grams/n liters | | |
|---|---|---|---|---|---|
| Chemical | mM | M.W. | n = 1.0 | n = 3.0 | n = 4.0 |
| NaCl | 100.00 | 58.5 | 5.85 | 17.55 | 23.40 |
| KCl | 14.00 | 74.6 | 1.04 | 3.13 | 4.18 |
| Glucose | 10.00 | 180 | 1.80 | 5.40 | 7.20 |
| Mannitol | 7.00 | 182 | 1.27 | 3.82 | 5.10 |
| MgSO₄ + 7H₂O | 15.00 | 246.5 | 3.70 | 11.09 | 14.79 |
| KH₂PO₄ | 1.20 | 136.1 | 0.16 | 0.49 | 0.65 |
| Sodium Pyruvate | 5.00 | 110 | 0.55 | 1.65 | 2.20 |
| Adenosine | 0.10 | 267 | 0.03 | 0.08 | 0.11 |
| Aprotinin (ml) | 200.00 | 10000 | 20 | 60 | 80 |
| | (KIU/L) | | | | |
| HEPES Free Acid | 6.0 | 238.3 | 1.43 | 4.29 | 5.72 |
| Tricine | 6.0 | 179 | 1.07 | 3.22 | 4.30 |
| NaOH | 6.20 | 40 | 0.25 | 0.74 | 0.99 |
| HES (grams) | — | — | 60 | 180 | 240 |
| BDM | 7.50 | 101.1 | 0.76 | 2.27 | 3.03 |
| CaCl₂/EDTA | | | 5.00 | 15.00 | 20.00 |
| Stock (ml) | | | | | |

(The CaCl₂/EDTA stock solution referred to on the previous line is the same as is used in the UR-Flush solution as described above. BDM is butanedione monoxime).

Adjust pH to 7.8 at room temperature, bring to final volume, & pass through a 0.22 micron filter (e.g., Millipore™ filter) to sterilize.

Ionic composition: Na: ˜111.2 mM neglecting any contamination from NaCl in the HES; K: ˜15.2 mM; Mg: ˜15 mM; Ca: ˜0.28 mM; Cl: ˜114.6 mM neglecting any contamination from NaCl in the HES; osmolality ˜326 mOsm plus the osmotic contribution of HES and any NaCl contaminating the HES.

Variants of UR-IP in which all components can vary by about ±25% will also be effective in the invention, provided total osmolality also remains within about ±25% of the osmolality of UR-IP as described above.

Experiment 5: Preservation of the Canine Heart for 49 Hours Using Two Bouts of IP

A donor heart was arrested with one liter ice-cold UR-Flush solution and stored in 800 ml ice-cold UR-Flush solution. Twenty-eight hours later, the heart was weighed and perfused for 35 min at 22° C. with 2 liters of oxygenated UR-intermittent perfusion solution (UR-IP) at 62.5 mmHg. After 17.5 min of perfusion, the pH of the collected coronary effluent was readjusted to pH 7.8 and recirculated back into the perfusate reservoir. Upon completion of the full 35 min perfusion period, the wet weight of the heart was determined once again, and the heart was stored in 800 ml ice-cold UR-intermittent perfusion solution. Sixteen hours later, after a total preservation time of 44 hours, the heart was weighed again and perfused a second time, this time for 20 min at room temp with 2 liters oxygenated UR-intermittent perfusion solution at 62.5 mmHg. After 13.5 min of perfusion, the pH of the collected coronary effluent was again readjusted to pH 7.8 and recirculated back into the perfusate reservoir. Upon completion of this second perfusion, the wet weight of the heart was again determined, and the heart was stored in 800 ml ice-cold UR-intermittent perfusion solution. The final transplantation of the heart was completed when the aortic cross-clamp was released 5 hours and 16 minutes later, for a total preservation time of 49 hours and 16 minutes. The recipient was off bypass 34 minutes later, and hemodynamic function was followed for exactly 6 hours, at which time the experiment was terminated.

The weight gains observed are given below.

| | | Temp | Duration | Flow rate | Weight |
|---|---|---|---|---|---|
| | IP bout when | ° C. | min | (ml/min/g) | Gain (g) |
| 1^{st} IP | 28 h of storage | 22 | 35 min | 0.57 | 15 |
| 2^{nd} IP | 44 h of storage | 22.7 | 20 min | 0.74 | 49 |

The weight gain after the 2^{nd} intermittent perfusion was large and the heart seemed stiffer relative to itself prior to the 2^{nd} perfusion. But the heart became soft at the time of reimplantation. After reimplantation and restablishment of blood flow to the heart, the heart was defibrillated quite easily with 3 shocks of 30 joule/sec. No pacing was needed. Isoproterenol drip (0.6 micrograms/ml/kg; recipient weight was 21 kg) was continued for the entire 6 hours after weaning the recipient off bypass, but was tapered to 0.1 micrograms/ml/kg by the end of the 6 hours.

The functional performance of this heart is described in the table below.

Hemodynamic function of the grafted heart at different hours after weaning off bypass

| | Hours | | | | |
|---|---|---|---|---|---|
| Time | off pump | HR | SAP | DAP | % EF |
| 15:05 | 0 | | | | |
| 16:06 | 1 | 117 | 119 | 67 | |
| 17:05 | 2 | 86 | 126 | 75 | |
| 18:05 | 3 | 103 | 133 | 73 | 65-70 |
| 19:05 | 4 | 101 | 130 | 70 | |
| 20:05 | 5 | 99 | 152 | 79 | |
| 21:05 | 6 | 99 | 142 | 78 | 60-65 |

As can be seen, the heart rate (HR) was within normal limits, as was the systolic arterial pressure (SAP), the diastolic arterial pressure (DAP), and the ejection fraction (% EF). The ejection fraction for normal human hearts is 60-65%, so the above performance is at least as good as what would be expected for a fresh heart.

Further, it should be apparent that many modifications may be made to the present invention without departing from the essential teachings of the invention. Accordingly, it will be understood by those skilled in the art that, within the scope of the appended claims, the invention may be practiced in embodiments other than those specifically described in this application.

1. A method of extending the viable life of an explanted mammalian heart, comprising:
a. storing the heart in a cold environment of less than 10° C.; and
b. perfusing the heart with warm perfusate of between 10° C. and 39° C. for a period of approximately five (5) minutes to thirty (30) minutes; after storing the heart in the cold environment for a period of up to approximately twenty-four (24) hours.

2. A method of extending the viable life of an explanted mammalian heart, comprising:
storing the heart in a cold environment of less than 10° C.;
perfusing the heart with warm perfusate of between 10° C. and 39° C. for a period of approximately five (5) minutes to thirty (30) minutes; after storing the heart in the cold environment for a period of up to approximately twenty-four (24) hours;
perfusing the heart with cold perfusate of less than 10° C.; and
continuing to store the heart in the cold environment for a period of up to approximately seventeen (17) hours after the period of cold perfusion.

3. A method of extending the viable life of an explanted mammalian heart, comprising:
a. storing the heart in a cold environment of less than 10° C.;
b. perfusing the heart with warm perfusate of between 10° C. and 39° C. for a period of approximately five (5) minutes to thirty (30) minutes; after storing the heart in the cold environment for a period of up to approximately twenty-eight (28) hours;
c. perfusing the heart with cold perfusate of less than 10° C.;
d. perfusing the heart with the warm perfusate for approximately five (5) minutes to thirty (30) minutes; after storing the heart in the cold environment for a period of up to approximately seventeen (17) hours after perfusing the heart with the cold perfusate; and
e. perfusing the heart with cold perfusate of less than 10° C.

4. The method of claim 1, 2 or 3 in which the perfusate is selected from the group consisting of UR-IP Solution, UR-IP-Flush Solution, CP-11H, CP-11EB, and UW Solution.

5. The method of claim 1, 2 or 3 in which the cold environment is a temperature at or near the melting point of ice.

6. The method of claim 1, 2 or 3 in which the temperature of the warm perfusate is between 20° C. and 34° C.

7. The method of claim 1, 2 or 3 in which the temperature of the warm perfusate is between 15° C. and 37° C.

8. The method of claim 1 wherein the method further comprises transplanting the heart.

9. The method of claim 2 wherein the method further comprises transplanting the heart.

10. The method of claim 3, wherein the method further comprises transplanting the heart within approximately four (4) hours after the warm perfusion of step (d).

11. A device for preserving an explanted mammalian heart, comprising:
an intermittent perfusion chest having a warm compartment and a cold compartment,
an organ reservoir disposed within the cold compartment,
a perfusate bag disposed within the warm compartment,
a warm perfusate tube operably connected at one end to the perfusate reservoir and, at the tube's other end, to the organ reservoir;
a cold perfusate tube operably connected at one end to the perfusate reservoir and, at the tube's other end, to the organ reservoir;
an extensible air bag adjacent to the perfusate reservoir;
an air pump operably connected to the air bag;
an effluent reservoir; and
an effluent tube operably connected at one end to the effluent reservoir and, at the tube's other end, to the organ reservoir.

12. The device of claim 11 further including a controller which controls the operation of the air pump, which supplies air to the air bag, causing the air bag to extend and to, in turn, compress the perfusate bag.

13. The device of claim 11 further comprising a perfusate valve which allows warm perfusate to flow within the warm perfusate tube to the organ reservoir.

14. The device of claim 15 further comprising a perfusate valve which allows cold perfusate to flow within the cold perfusate tube to the organ reservoir.

15. The device of claim 15 in which the perfusate reservoir contains perfusate.

16. The device of claim 15 in which the cold compartment contains ice.

17. The device of claim 15 in which the cold compartment contains approximately 23-24 liters of accessible space.

18. The device of claim 15 in which the perfusate reservoir, in its extended configuration, can contain approximately 12 liters of perfusate.
